(19) United States
(12) Patent Application Publication
(10) Pub. No.: US 2002/0163213 A1
(43) Pub. Date: Nov. 7, 2002

(54) Winch hook holder

(76) Inventor: Donald L. Ferguson JR., Dearborn Heights, MI (US)

Correspondence Address: Gifford, Krass, Groh,, Sprinkle, Anderson & Citkowski, PC, Suite 400, 280 N. Old Woodward Ave., Birmingham, MI, 48009, US

(21) Appl. No.: 10/179,118

(22) Filed: Jun. 25, 2002

Related U.S. Application Data
(63) Continuation-in-part of application No. 09/664,206, filed on Sep. 18, 2000, now Pat. No. 6,409,240.

(51) Int. Cl. B25J 1/00

(52) U.S. Cl. 294/19.1

(57) ABSTRACT

A winch hook holding device includes a body having a proximal end connected to an elongated handle and a distal portion including a hook-shaped curved cradle for at least temporarily holding a winch hook. The cradle features a curved recess corresponding to the back surface of the hook and an opening corresponding to the opening of the hook, enabling the hook to be supported in the cradle and brought to the eyelet and released from the cradle once engaged. An alternative embodiment further includes a biasing element such as a spring-loaded lever disposed within a portion of the groove for applying pressure to the hook for active retainment therein. The connector at the proximal end of the handle preferably includes a threaded connector that mates with an elongated handle having a threaded end, thereby allowing handles available for other purposes to be utilized. Custom handles may also be provided according to the invention, including telescoping varieties. Preferably the hook-holding body is a unitary piece of molded plastic.

### REFERENCE TO RELATED APPLICATION

This application is a continuation-in-part of U.S. patent application Ser. No. 09/664,206, filed Sep. 18, 2000. The entire content of this application is incorporated herein by reference.

### FIELD OF THE INVENTION

This invention relates generally to apparatus for holding and reaching and, more particularly, to apparatus for holding a winch hook of the type coupled to the bow of a boat when loading the boat onto a trailer.

### BACKGROUND OF THE INVENTION

Small boats such as row boats and powered fishing boats, and the like, are conveniently hauled by cars and trucks using trailers suitable for highway use. Such boats are unloaded into the water, the driver generally backs the rig down a ramp until the boat becomes buoyant, then pulls the trailer out of the water, leaving the boat free for use.

To load the boat back onto the trailer, a hook coupled to a winch is fastened to the bow end of the boat with the trailer in the water, and the winch is cranked to pull the boat back onto the trailer. In contrast to the unloading, however, where the boat may first be unfastened then guided into the water to become buoyant, the loading operation typically requires a person to attach the winch hook to the bow end of the boat while the boat is floating in the water. Although the trailer is generally at least partially submerged at this time as well, the boat is typically far enough away from the trailer that the individual must either wade in the water or stand on the trailer and attempt to reach the boat by hand. In any event, the person either gets wet or must strain to grab the vessel, often requiring the help of others.

What is needed is an extension arm that can be used to at least temporarily hold the winch hook at a distance extended from the back of the trailer, thereby enabling the individual to reach the ring or cleat used to catch the winch hook. One invention exists for this purpose, but it has limitations. U.S. Pat. No. 5,215,344, entitled “Winch Cable Attachment Apparatus,” disclosed an attachment for releasably gripping a hook at one end of a winch cable to facilitate coupling of the hook to a boat that is pulled from the water. However, the solution set forth in this patent has a body provided with a hook-accommodating slot in one side thereof and a groove in the opposite side thereof for accommodating an elongated support. Although the slot is tapered with side walls between which the hook may be wedged, thereby allowing for differently-sized winch hooks, the apparatus serves no purpose other than winch hook engagement, and should the resilient material used to capture the hook become worn or broken, operation of the device may become further limited.

### SUMMARY OF THE INVENTION

The present invention resides in a winch hook holding device attached to an elongated handle. The device includes a body having a proximal end connected to the handle and a distal portion including a hook-shaped curved cradle for at least temporarily holding the winch hook. Thus, in contract to existing devices, the winch hook holding portion is itself hook-shaped, enabling the tool to be used for other snaring purposes when a winch hook is not retained therein.

In the preferred embodiment, the cradle features a curved recess corresponding to the back surface of the hook and an opening corresponding to the opening of the hook, enabling the hook to be supported in the cradle and brought to the eyelet and released from the cradle once engaged. An alternative embodiment further includes a biasing element such as a spring-loaded lever disposed within a portion of the groove for applying pressure to the hook for active retainment therein.

The connector at the proximal end of the handle preferably includes a threaded connector that mates with an elongated handle having a threaded end, thereby allowing handles available for other purposes to be utilized. Custom handles may also be provided according to the invention, including telescoping varieties. Preferably the hook-holding body is a unitary piece of molded plastic.

### BRIEF DESCRIPTION OF THE DRAWINGS

FIG. 1 is a perspective-view drawing of a preferred embodiment according to the invention;

FIG. 2 is a perspective-view drawing of an alternative embodiment of the invention incorporating a spring-biased feature for active engagement, including engagement of differently-sized winch hooks;

FIG. 3A is a front-view drawing of a hook holder according to the present invention, showing preferred dimensions;

FIG. 3B is a side-view drawing, in partial cross-section, of the holder of FIG. 3A, showing preferred dimensions;

FIG. 3C is a back-view drawing of the holder of FIG. 3A showing preferred dimensions;

FIG. 4 is a side-view drawing of a hook holder according to the present invention with a telescoping handle; and

FIG. 5 shows an alternative embodiment of the invention incorporating a spring-biased finger device that slides back and forth with assistance of a spring to accommodate differently-sized winch hooks.

### DETAILED DESCRIPTION OF THE INVENTION

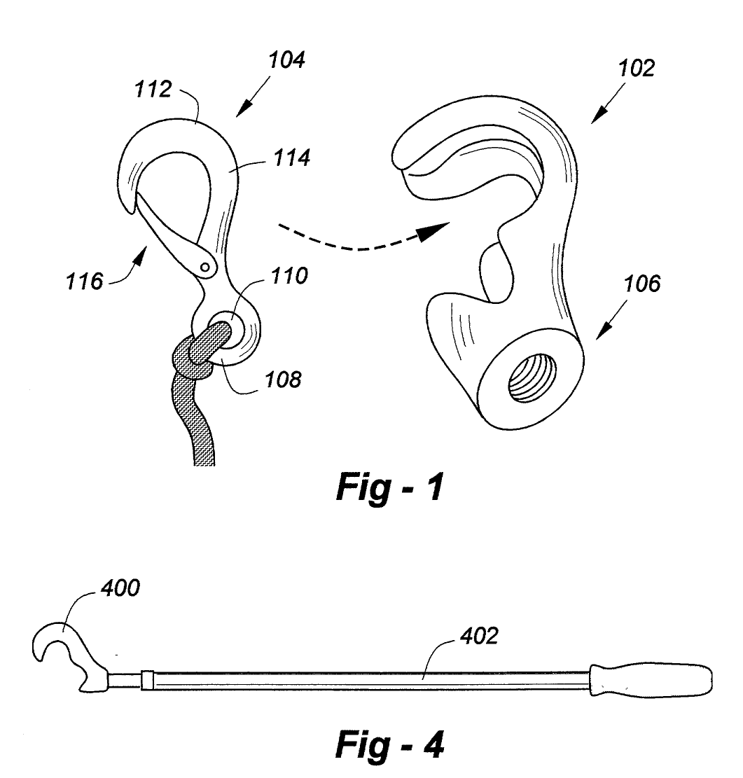

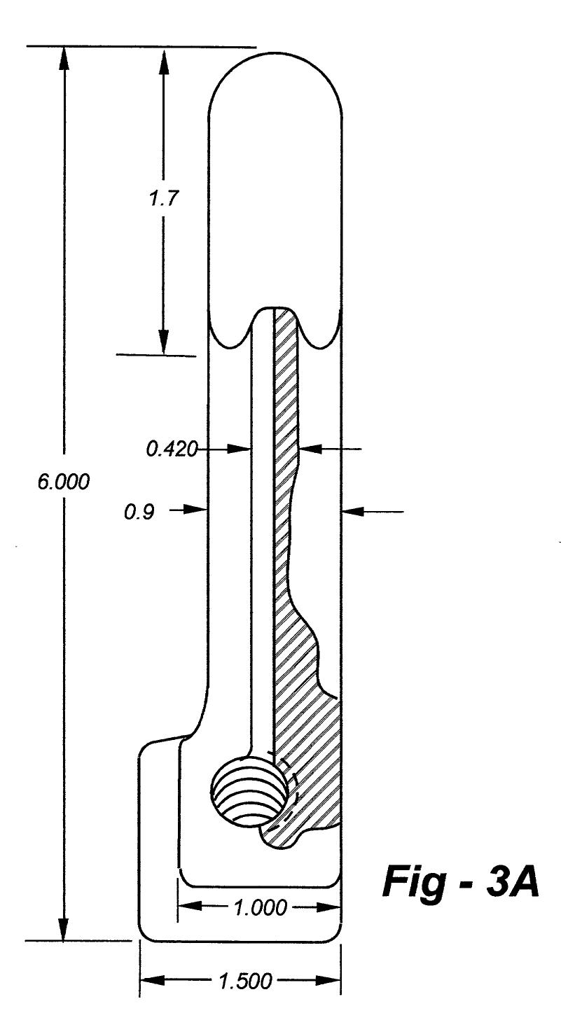

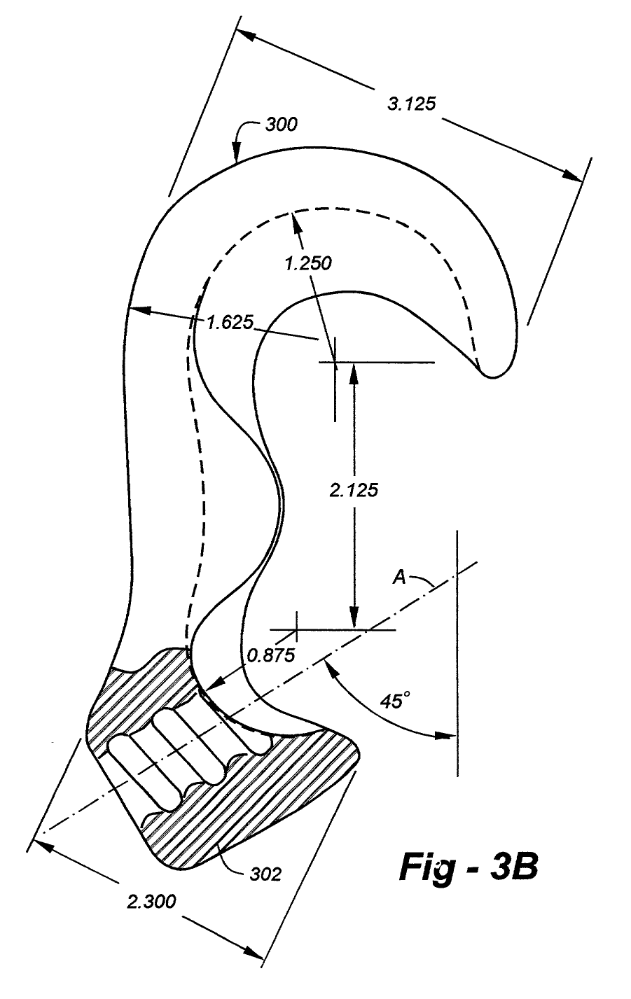

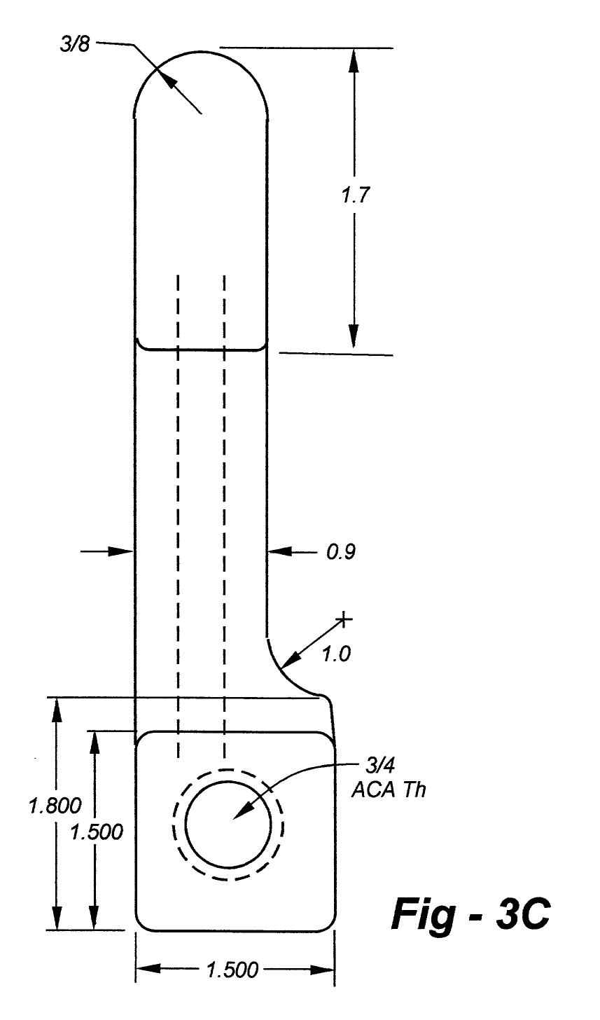

FIG. 1 is a drawing seen from an oblique perspective illustrating a preferred embodiment of the invention for holding a winch hook 104. As shown, the hook 104 has a base 108 with a hole 110 to find therethrough. The hook 104 also has a hook-shaped curved end 112 extending therefrom. The curved end 112 has a curved back surface 114 and an opposing opening 116 to receive an eyelet. Broadly, the winch hook holder includes a distal portion 102 featuring a grooved cavity dimensioned to receive the winch hook 104 therein. At the proximal end 106 of the device, there is preferably included a threaded hole 108 allowing the holder to be coupled to a standard threaded pole of the type used to extend household implements such as paint rollers, cleaning tools, and so forth. Although a threaded connection is shown, it will be appreciated that an integral connection to an extension pole is also anticipated by the invention, and that telescoping poles may conveniently be used in some circumstances where smaller size is desirable for stowage. A preferred set of dimensions associated with the preferred embodiment are provided with respect to FIG. 3.

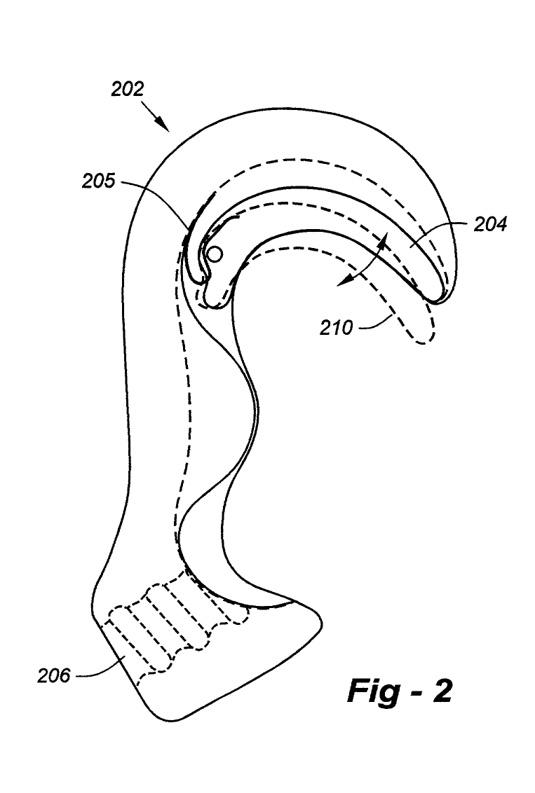

FIG. 2 illustrates an alternative embodiment of the invention similarly including a threaded proximal end 206, but wherein the distal portion 202 further inches a optionally grooved appendage 204 biased by spring 208 between positions indicated by the two-headed arrow and broken line 210. The configuration of FIG. 2 is useful where, for instance, smaller or unconventionally sized winch hooks may nevertheless need to be firmly secured.

FIGS. 3A-C are engineering-type drawings which show important dimensions associated with the preferred embodiment of the invention of FIG. 1. It will be appreciated that these parameters may be varied in accordance with the invention, so long as the hook capturing and holding principles disclosed herein are maintained. The overall length of the device is approximately 6 inches, and has a width of approximately 3.5 inches, or thereabouts. The device may be manufacturing from any suitable material, including metal and plastics, though a molded plastic is used in the preferred embodiment. Referring to FIG. 3B, it will be appreciated that the hook holder 300 has a proximal end 302 which connects to an elongated handle. FIG. 4 shows a hook holder 400 connected to handle 402. Referring again to FIG. 3B, the elongated handle, once connected to the hook holder 300, may be said to have a central axis. This central axis is shown by line A. It will be appreciated by those of skill in the art that a winch hook, once properly positioned in the hook holder 300, is positioned at an angle to the central axis A. If a plane is defined which contains the central axis A, the hook shaped curved end of the winch hook will be located such that it is entirely on one side of the plane containing the central axis A, with the opening in the hook facing the plane. Also, the hole 110 in the base 108 of the hook 104 will be located on the axis. The angle between the hook and the axis is an acute angle.

Note that the threaded portion at the proximal end is preferably angled at 45 degrees, or thereabouts, relative to the length of the holding body portion, to allow for easier capture of the hook or cleat with the winch hook once retained.

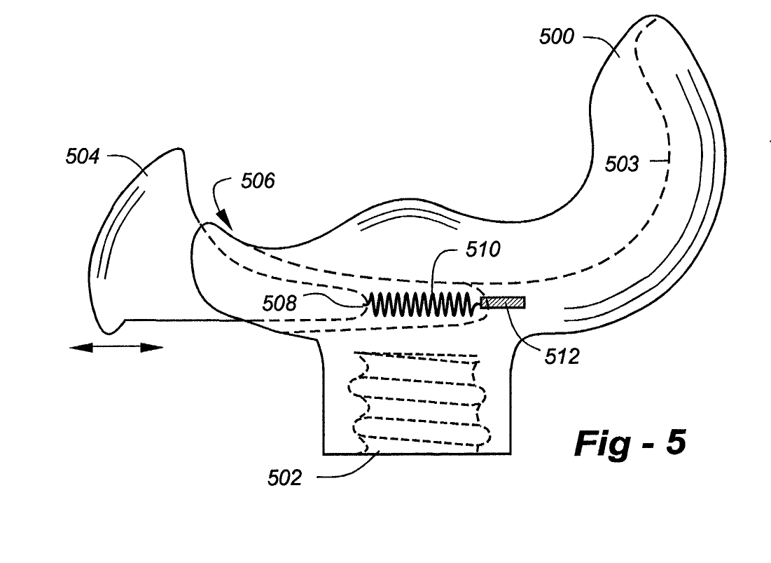

FIG. 5 is a drawing which illustrates yet a further alternative embodiment of the invention utilizing a slidably engaged spring-biased member. In particular, this embodiment includes a curved body 500 having an end 502 optionally threaded for engagement with a pole (not shown), and a curved recess 503 to engage with the curved back side of the winch hook. A member 504, is slidably engaged within a cavity 506, bias by a spring 510 connected at one end 508 to the member 504, and to a locking pin 512. As such, the member 504 is able to slide back and forth as shown by the two-headed arrow, thereby actively engaging differently-sized winch hooks, similar to the embodiment depicted with respect to FIG. 2.

I claim:

1. A device configured for attachment to an elongated handle for temporarily holding a winch hook of the type having a curved back surface and an opening to engage with an eyelet, the device comprising:
a body having a proximal end and a distal portion;
the proximal end including a connector for attaching the body to the elongated handle; and
the distal portion including a curved cradle corresponding to the back surface of the hook, the cradle including an opening corresponding to the opening of the hook, enabling the hook to be supported in the cradle and released once the hook is engaged with an eyelet.

2. The device according to claim 1, further including a biased finger operative to change the size of the cradle so as to accommodate differently size winch hooks.

3. The device according to claim 3, wherein the finger a spring-loaded lever.

4. The device according to claim 1, further including:
an elongated handle includes a threaded end; and
the connector at the proximal end of the handle is a threaded connector that mates with the threaded end of the handle.

5. The device according to claim 4, wherein the handle is a telescoping handle.
